(19) United States
(12) Patent Application Publication
(10) Pub. No.: US 2009/0089400 A1
(43) Pub. Date: Apr. 2, 2009

(54) Method of playing real time audio and video signals via a network platform

(75) Inventors: Huan-Yun Wei, Taipei City (TW); You-Hsin Yen, Taipei City (TW); Yi-Hsiang Lin, Taipei City (TW)

Correspondence Address: BACON & THOMAS, PLLC, 625 SLATERS LANE, FOURTH FLOOR, ALEXANDRIA, VA, 22314-1176, US

(73) Assignee: D-Link Corporation, Taipei City (TW)

(21) Appl. No.: 11/979,865

(22) Filed: Nov. 9, 2007

(30) Foreign Application Priority Data
Oct. 1, 2007 (TW) 096136808

(51) Int. Cl. G06F 15/173

(52) U.S. Cl. 709/218

(57) ABSTRACT

A method of playing real time audio and video signals via a network platform is applied to a network system, which comprises a server at an internet service provider (ISP) having a network platform comprising at least one user selectable icon corresponding to a web camera being connected to said server via internet, and comprises the steps of when said web camera is turned on and is connected to said network platform, said network platform making said icon enter a standby mode; when a computing device is connected to said server via internet and logged on to said network platform, and said icon in standby mode is clicked, said network platform establishing a connection channel between said web camera and said computing device; and transmitting audio and video signals captured by said web camera via internet and directly through said connection channel to said computing device in real time.

### FIELD OF THE INVENTION

The present invention relates to a method of playing real time audio and video signals via a network platform. More precisely, the present invention relates to a method of playing real time audio and video signals via a network platform where the bandwidth of a server at an Internet Service Provide can be offloaded to save potential expenses for extra bandwidth or physical space to store more serve machines.

### BACKGROUND OF THE INVENTION

Web cameras, which are also known as webcams or IP cameras, are a device with capability of capturing video images. It operates on the basic principle that video images of an object is captured and processed by its internal light sensing device and control device then converted to digital signals recognizable by a computer. Said signals are then fed through an USB cable to a computer for reconstruction of said video images and consequent real time display on a computer screen of said video images. Usually a remote electronic device can utilize some application programs to download images captured by a webcam through the internet.

The rapid improvement in digital photographic and network communication technologies has constantly lower the price of web cameras as well as increasing resolution and performance of related products. Such hardware products and bundled application software together are commonly used in our work place and daily life. Millions of web cameras have been installed in families and offices, on city streets and country sides all over the world to transmit local real time images of said places. Some web cameras are even applied in public security systems, traffic flow control and monitoring researches for whether and volcanic activities.

There are two types of video network platform adapted nowadays. One type of network platform stores video data in its server for users to download; the other type of network platform broadcasts on the internet so that users can connect via the internet at anytime to view live video. The video data is pre-stored and therefore non-live in the first type; while the video data in the second type is real time, it stays statically in its web site to wait for users' viewing. Currently there does not exist a network system that allows its registered member to log in to the web camera he/she is interested in viewing and before said web camera broadcasts live audio and video streams, inquires all on-line users' computing devices (e.g. notebook computers, personal digital assistants or mobile phones) whether a user intends to connect to said web camera and consequently watch said live audio and video streams.

As a result, it has become an common goal for all network service providers to research and develop a network platform which allows a user to easily install a web camera in a general network environment and establish a connection channel via said network platform so that all on-line users' computing devices are inquired or requested whether to connect to said web camera before said web camera starts broadcasting real time audio and video signals; and if such a request is granted, audio and video signals captured by said web camera is transmitted via internet and through said connection channel to said computing device in real time and displayed on a display screen of said computing device.

### SUMMARY OF THE INVENTION

As mentioned above, current network platform offered by conventional internet service providers (ISP) can not provide a service which requests all on-line users' computing devices whether they are interested in connecting to said web camera before said web camera starts broadcasting real time audio and video signals and enable a user to watch said broadcast if said request is granted. After considerable research and experimentation, a method of playing real time audio and video signals via a network platform of the present invention has been developed so that live audio and video signals captured by a web camera is transmitted via internet to a computing device in real time and displayed on a display screen of said computing device.

It is an object of the present invention to provide a method of playing real time audio and video signals via a network platform, said method is applied to a network system which comprises at least a web camera, at least a computing device (e.g. a notebook computer, personal digital assistant or mobile phone), internet and a server at an ISP. Said server at said ISP comprises a network platform, said network platform comprises at least one user selectable icon which corresponds to said web camera. Said web camera is connected to said server at said ISP via internet, when said web camera is turned on and is connected to said network platform, said network platform makes said icon enter a standby mode (e.g. icon shows a bright color). if said user is interested in said web camera and has added said web camera to a contact list of said computing device, when said computing device is connected to said server at said ISP via internet and logged on to said network platform, said user will be informed and inquired whether said user chooses to watch. If said user chooses to watch, said network platform then establishes a connection channel between said computing device and said web camera so that audio and video signals captured by said web camera is transmitted via internet and through said connection channel to said computing device in real time and displayed on a display screen of said computing device. Thereby by visiting said network system, said user can click a standby mode icon on said computing device to directly connect to said web camera and obtain real time audio and video signals.

It is another object of the present invention that all icons corresponding to those web cameras which are registered and connected on-line is reported by said network platform to said computing device so that a user can select a particular web camera to directly download the captured real time audio and video signals from said web camera without going through a server at an ISP's site. Consequently, the bandwidth of said server at said ISP can be offloaded to save potential expenses for extra bandwidth or physical space to store more serve machines.

### BRIEF DESCRIPTION OF THE DRAWINGS

The features, objects and advantages of the invention will become more apparent from the detailed description set forth below when taken in conjunction with the drawings in which like references characters identify correspondingly throughout, and wherein:

FIG. 1 is a representative diagram showing a network structure comprises of a web camera, a computing device, internet and a server at an ISP;

FIG. 2 is a representative diagram of a network system according to the present invention;

FIG. 3 is a representative diagram of a flow chart of a network system according to the present invention;

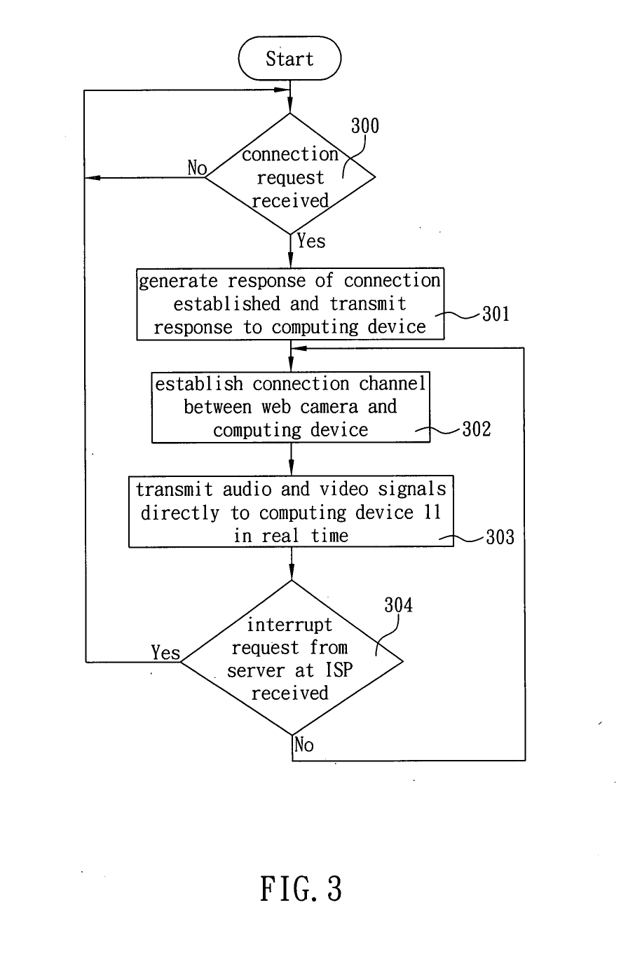

FIG. 4 is a representative diagram of a flow chart of a computing device according to the present invention.

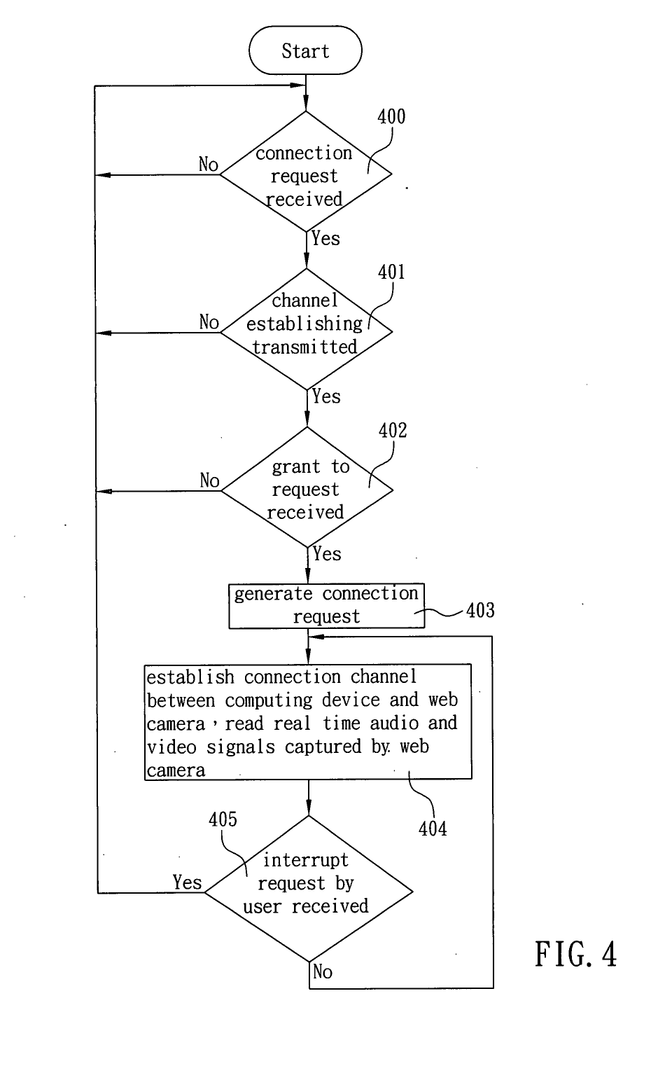

### DETAILED DESCRIPTION OF THE PREFERRED EMBODIMENTS

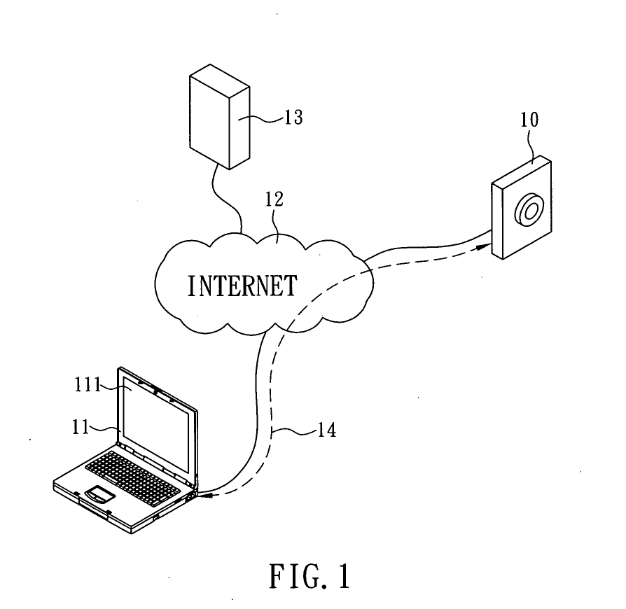

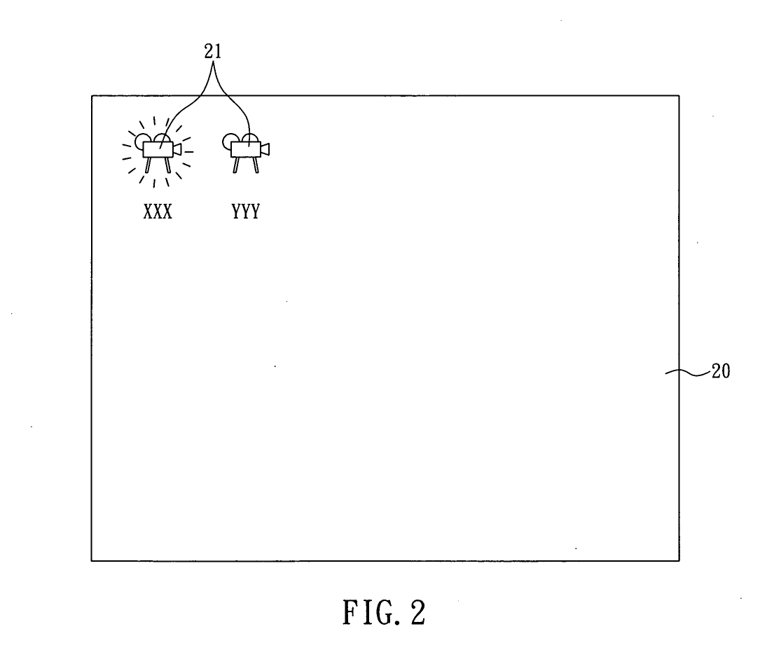

Refer to FIG. 1 for a method of playing real time audio and video signals via a network platform according to the present invention. Said method is applied to a network system which comprises at least a web camera 10, at least a computing device 11, internet 12 and a server 13 at an internet service provider (ISP). In the following preferred embodiment of the present invention, one web camera 10 and one computing device 11 (e.g. a notebook computer, personal digital assistant or mobile phone) are used as an example for explanation purposes only. Other embodiments may vary (e.g. two or more web cameras 10 or computing devices 11) without deviating from the scope of the present invention. Said server 13 at said ISP comprises a network platform 20 as shown in FIG. 2; said network platform comprises at least one user selectable icon 21 which corresponds to said web camera 10. Said web camera 10 is connected to said server 13 at said ISP via internet 12, when said web camera 10 is turned on and is connected to said network platform 20, said network platform 20 makes said icon 21 enter a standby mode (e.g. icon shows a bright color as shown in FIG. 2). Said computing device 11 is connected to said server 13 at said ISP via internet 12. After said computing device 11 has logged on to said network platform 20 and said icon 21 in standby mode is clicked, said network platform 20 then establishes a connection channel 14 between said computing device 11 and said web camera 10 so that audio and video signals captured by said web camera 10 is transmitted via internet 12 and directly through said connection channel 14 to said computing device 11 in real time and consequently displayed on a display screen 111 of said computing device 11.

Refer back to FIG. 1 for a preferred embodiment of the present invention. When the IP (Internet Protocol) address of said web camera 10 is registered to said network platform 20 constructed on said serve 13 at said ISP, the user providing said web camera 10 must input an identification name (e.g. XXX and YYY as shown in FIG. 2) corresponding to said IP address to said network platform 20 so that according to said IP address and said corresponding identification name, said network platform 20 can generate said icon 21 corresponding to said web camera 10. When said web camera 10 is detected to be turned on and a connection between said web camera 10 and said network platform 20 has been established, said network platform 20 then makes said corresponding icon 21 enter standby mode (as shown in FIG. 2, said icon 21 displays a bright color). As a result, after said IP address of said computing device 11 has been registered to said network platform 20, said network platform will transmit said icon 21 and identification name of said registered and connected web camera 10 to said computing device 11 for providing selections by user of said computing device 11. Therefore, when the user of said computing device 11 makes a selection on said network platform 20 according to his/her needs by clicking on said standby mode icon 21, said network platform 20 then establishes a connection channel 14 between said computing device 11 and said web camera 10 and said web camera 10 performs the following steps.
(300) determine whether a connection request by said computing device 11 has been received; if so, continue with step (301), otherwise stay in step (300);
(301) read said IP address of said computing device 11 included in said connection request and generate a response of connection established, and according to said IP address of said computing device 11, transmit said response to said computing device 11;
(302) establish said connection channel 14 between said web camera 10 and said computing device 11;
(303) transmit audio and video signals captured by said web camera 10 via internet 12 and directly through said connection channel 14 to said computing device 11 in real time; and
(304) determine whether an interrupt request from said server 13 at said ISP has been received; if so, go to step (300), otherwise go to step (302) until an interrupt request from said computer device 11 is received.

Furthermore, if said user is interested in said web camera and has added said web camera 10 to a contact list of said computing device 11, when said computing device 11 is connected to said server 13 at said ISP via internet 12 and logged on to said network platform 20, said computing device performs the steps of: (400) determine whether a channel establishing request by said server 13 at said ISP has been received; if so, continue to step (401), otherwise stay in step (400);
(401) determine whether an instruction to accept said channel establishing request is inputted by user, and whether a channel establishing response to said server 13 at said ISP has been transmitted; if so, continue to step (402), otherwise go to step (400);
(402) determine whether a grant to said request by said server 13 at said ISP has been received; if so continue to step (403), otherwise go to step (400);
(403) read said IP address of said web camera 10 included in said grant and generate a connection request for establishing channel and transmit said connection request to said web camera 10;
(404) after said connection response transmitted by said web camera 10 has been received, establish said connection channel 14 between said computing device 11 and said web camera 10, and read audio and video signals captured by said web camera 10 and transmitted by said web camera 10 via internet 12 and directly through said connection channel 14 to said computing device 11 in real time and display said audio and video signals on display screen 111 of said computing device 11; and
(405) determine whether an interrupt request inputted by said user has been received; if so, go to step (400), otherwise go to step (404) until an interrupt request from said web camera 10 is received.

Refer to FIG. 1 again. From the above detailed descriptions, web camera can directly transmit the captured real time audio and video signals to said computing device 11 without going through the server 13 at an ISP's site. Consequently, the bandwidth of said server 13 at said ISP can be offloaded to save potential expenses for extra bandwidth or physical space to store more serve machines.

We have to emphasize that the above-mentioned is only a preferred embodiment of the present invention and in no way limit the endless approaches of invention. One of many modifications and variations could be, when said connection channel 14 is established between said computing device 11 and said web camera 10, if said computing device 11 or said web camera 10 detects the wait time in any one of the ensuing steps exceeds a pre-determined length of time, or an interrupt request from said server 13 at said ISP is received, said computing device can automatically go back to step 400 to determine whether a channel establishing request from said server 13 has been received, or said web camera 10 can automatically go back to step 300 to determine whether a connection request by said computing device 11 has been received.

While the invention has been described by means of specific embodiments, numerous modifications and variations could be made thereto by those skilled in the art without departing from the scope and spirit of the invention set forth in the claims.

What is claimed is:

1. A method of playing real time audio and video signals via a network platform, said method being applied to a network system, said network system comprising at least a web camera, at least a computing device, internet and a server at an internet service provider (ISP), said server at said ISP comprising a network platform, said network platform comprises at least one user selectable icon, said icon being corresponding to said web camera, said web camera being connected to said server at said ISP via internet, said method comprising the steps of:
when said web camera is turned on and is connected to said network platform, said network platform making said icon enter a standby mode;
when said computing device is connected to said server at said ISP via internet and logged on to said network platform, and said icon in standby mode is clicked, said network platform establishing a connection channel between said computing device and said web camera; and
transmitting audio and video signals captured by said web camera via internet and directly through said connection channel to said computing device in real time.

2. The method of claim 1, wherein said method further comprising the steps of:
registering IP address of said web camera and a corresponding identification name to said network platform; and p1 according to said IP address and said corresponding identification name, said network platform generating said icon corresponding to said web camera.

3. The method of claim 2, wherein said method further comprising the step of:
when said web camera is detected to be turned on and a connection between said web camera and said network platform has been established, said network platform making said corresponding icon enter standby mode with a bright color.

4. The method of claim 3, wherein said method further comprising the step of:
when said IP address of said computing device has been registered to said network platform, said network platform transmitting said icon and identification name of said registered and connected web camera to said computing device for providing selections by user of said computing device.

5. The method of claim 4, wherein said web camera performs the steps of:
determining whether a connection request by said computing device has been received;
reading said IP address of said computing device included in said connection request and generating a response of connection established;
according to said IP address of said computing device, transmitting said response to said computing device, then establishing said connection channel between said web camera and said computing device; and
transmitting audio and video signals captured by said web camera via internet and directly through said connection channel to said computing device in real time.

6. The method of claim 5, wherein said computing device performs the steps of:
determining whether a channel establishing request by said server at said ISP has been received;
determining whether an instruction to accept said channel establishing request is inputted by user, and whether a channel establishing response to said server at said ISP has been transmitted;
determining whether a grant to said request by said server at said ISP has been received;
reading said IP address of said web camera included in said grant and generating a connection request for establishing channel and transmitting said connection request to said web camera; and
after said connection response transmitted by said web camera has been received, establishing said connection channel between said computing device and said web camera, and reading audio and video signals captured by said web camera and transmitted by said web camera via internet and directly through said connection channel to said computing device in real time and displaying said audio and video signals on a display screen of said computing device.
